(19) United States
(12) Patent Application Publication
(10) Pub. No.: US 2012/0301352 A1
(43) Pub. Date: Nov. 29, 2012

(54) METAL ION CATALYSIS OF METAL ION REDUCTION, METHODS, COMPOSITIONS, AND ARTICLES

(75) Inventor: David R. Whitcomb, Woodbury, MN (US)

(73) Assignee: Carestream Health, Inc.

(21) Appl. No.: 13/449,354

(22) Filed: Apr. 18, 2012

Related U.S. Application Data
(60) Provisional application No. 61/488,846, filed on May 23, 2011.

(51) Int. Cl. B22F 1/00; B82Y 40/00

(52) U.S. Cl. 420/591; 75/343; 977/896

(57) ABSTRACT

Methods for preparing metal nanowires in the presence of IUPAC Group 15 ions are disclosed. Such methods are capable of producing high aspect ratio nanowires that are suitable for electronics applications.

### CROSS REFERENCE TO RELATED APPLICATIONS

This application claims the benefit of U.S. Provisional Application No. 61/488,846, filed May 23, 2011, entitled METAL ION CATALYIS OF METAL ION REDUCTION, METHODS, COMPOSITIONS, AND ARTICLES, which is hereby incorporated by reference in its entirety.

### BACKGROUND

The general preparation of silver nanowires (10-200 aspect ratio) is known. See, for example, Angew. Chem. Int. Ed., 2009, 48, 60, Y. Xia, Y. Xiong, B. Lim, S. E. Skrabalak, which is hereby incorporated by reference in its entirety. Such preparations typically employ Fe²⁺ or Cu²⁺ ions to “catalyze” the wire formation over other morphologies. The controlled preparation of silver nanowires having desired lengths and widths, however, is not known. For example, the Fe²⁺ produces a wide variety of lengths or thicknesses and the Cu²⁺ produces wires that are too thick for many applications.

When iron or copper are used, they are typically provided as the metal halide salts FeCl₂ or CuCl₂. See, for example, B. Wiley et al., Nano Letters, 2004, 4, 1733-1739 and K. E. Korte et al., J. Mats. Chem., 2008, 18, 437. Other metal halide salts have been used in nanowire synthesis. See, for example, J. Jiu, K. Murai, D. Kim, K. Kim, K. Suganuma, Mat. Chem. & Phys., 2009, 114, 333, which refers to NaCl, CoCl₂, CuCl₂, NiCl₂ and ZnCl₂, and S. Nandikonda, “Microwave Assisted Synthesis of Silver Nanorods,” M.S. Thesis, Auburn University, Auburn, Ala., USA, Aug. 9, 2010, which refers to NaCl, KCl, MgCl₂, CaCl₂, MnCl₂, CuCl₂, and FeCl₃, and Japanese patent application publication 2009-155674, which discloses SnCl₄.

### SUMMARY

At least a first embodiment comprises methods comprising providing a composition comprising at least one first compound comprising at least one first reducible metal ion; at least one second compound comprising at least one second metal or metal ion differing in atomic number from said at least one first reducible metal, said at least one second metal or metal ion comprising at least one element from IUPAC Group 15, and at least one solvent; and reducing the at least one first reducible metal ion to at least one first metal nanowire. In at least some cases, the at least one first reducible metal ion comprises at least one coinage metal ion, or at least one ion of an element from IUPAC Group 11, or at least one silver on.

In at least some embodiments, the at least one second metal or metal ion comprises bismuth or an ion of bismuth. Such a metal ion may, in some cases, be in its +3 oxidation state. The at least one second compound may, for example, comprise at least one salt of said at least one second metal or metal ion. Such a salt may, for example, comprise at least one chloride.

In such methods, the at least one solvent may, for example, comprise at least one polyol.

Other embodiments provide the at least one first metal nanowire produced according to such methods.

At a second embodiment provides methods comprising providing a composition comprising at least one first compound comprising at least one reducible metal ion, at least one second compound comprising at least one second metal or metal ion differing in atomic number from the at least one first reducible metal ion, the second metal or metal ion comprising at least one element from IUPAC Group 15, and at least one solvent; and reducing the at least one first reducible metal ion to at least one first metal. The at least one first reducible metal ion may, for example, comprise at least one coinage metal ion, or at least one ion of an element from IUPAC Group 11, or at least one silver ion. The at least one first compound may, for example, comprise silver nitrate. The at least one second metal or metal ion may, for example, comprise bismuth or an ion of bismuth. The at least one second compound may, for example, comprise at least one salt of the at least one second metal or metal ion. Such a salt may, for example, comprise at least one chloride. The at least one solvent may, for example, comprise at least one polyol, or at least one of ethylene glycol, propylene glycol, glycerol, one or more sugars, or one or more carbohydrates. In some embodiments, the ratio of the total moles of the at least one second metal or metal ion to the total moles of the at least one first reducible metal ion is from about 0.0001 to about 0.1. The reduction may, for example, be carried out at one or more temperatures from about 90° C. to about 190° C.

In at least some embodiments, the composition further comprises at least one protecting agent. In some cases, the at least one protecting agent comprises at least one of: one or more surfactants, one or more acids, or one or more polar polymers. The at least one protecting agent may, for example, comprise polyvinylpyrrolidinone. At least some embodiments further comprise inerting the at least one protecting agent.

Other embodiments further comprise inerting one or more of the composition, the at least one compound comprising the at least one first reducible metal ion, the at least one second metal or metal ion, or the at least one solvent. Still other embodiments provide the at least one first metal produced by such methods and articles comprising such at least one first metal. Such at least one first metal may, for example, comprise one or more nanowires, nanocubes, nanorods, nanopyramids, nanotubes, and the like. Such at least one first metal may comprise at least one object having an average diameter of between 10 nm and about 500 nm, or having an aspect ratio from about 50 to about 10,000.

Yet still other embodiments provide at least one metal nanowire with an average diameter between about 10 nm and about 150 nm, with an aspect ratio from about 50 to about 10,000. Such nanowires may, for example, comprise at least one coinage metal, or at least one element of IUPAC Group 11, or silver. Yet another embodiment comprises at least one article comprising such metal nanowires, such as, for example, at least one electronic device.

These and other embodiments will be understood by the brief description of figures, description, exemplary embodiments, examples, and claims that follow.

### BRIEF DESCRIPTION OF FIGURE

FIG. 1 shows an optical micrograph of the silver nanowire product of Example 1.

### DESCRIPTION

All publications, patents, and patent documents referred to in this document are incorporated by reference herein in the entirety, as though individually incorporated by reference.

U.S. Provisional Application No. 61/488,846, filed May 23, 2011, entitled METAL ION CATALYIS OF METAL ION REDUCTION, METHODS, COMPOSITIONS, AND ARTICLES, is hereby incorporated by reference in its entirety.

### Reducible Metal Ions and Metal Products

Some embodiments provide methods comprising reducing at least one reducible metal ion to at least one metal. A reducible metal ion is a cation that is capable of being reduced to a metal under some set of reaction conditions. In such methods, the at least one first reducible metal ion may, for example, comprise at least one coinage metal ion. A coinage metal ion is an ion of one of the coinage metals, which include copper, silver, and gold. Or such a reducible metal ion may, for example, comprise at least one ion of an IUPAC Group 11 element. An exemplary reducible metal ion is a silver cation. Such reducible metal ions may, in some cases, be provided as salts. For example, silver cations might, for example, be provided as silver nitrate.

In such embodiments, the at least one metal is that metal to which the at least one reducible metal ion is capable of being reduced. For example, silver would be the metal to which a silver cation would be capable of being reduced.

### Nanostructures, Nanostructures, and Nanowires

In some embodiments, the metal product formed by such methods is a nanostructure, such as, for example, a one-dimensional nanostructure. Nanostructures are structures having at least one “nanoscale” dimension less than 300 nm, and at least one other dimension being much larger than the nanoscale dimension, such as, for example, at least about 10 or at least about 100 or at least about 200 or at least about 1000 times larger. Examples of such nanostructures are nanorods, nanowires, nanotubes, nanopyramids, nanoprisms, nanoplates, and the like. “One-dimensional” nanostructures have one dimension that is much larger than the other two dimensions, such as, for example, at least about 10 or at least about 100 or at least about 200 or at least about 1000 times larger.

Such one-dimensional nanostructures may, in some cases, comprise nanowires. Nanowires are one-dimensional nanostructures in which the two short dimensions (the thickness dimensions) are less than 300 nm, preferably less than 100 nm, while the third dimension (the length dimension) is greater than 1 micron, preferably greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are preferred in some such applications.

Such methods may be used to prepare nanostructures other than nanowires, such as, for example, nanocubes, nanorods, nanopyramids, nanotubes, and the like. Nanowires and other nanostructure products may be incorporated into articles, such as, for example, electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like.

### Preparation Methods

A common method of preparing nanostructures, such as, for example, nanowires, is the “polyol” process. Such a process is described in, for example, Angew. Chem. Int. Ed. 2009, 48, 60, Y. Xia, Y. Xiong, B. Lim, S. E. Skrabalak, which is hereby incorporated by reference in its entirety. Such processes typically reduce a metal cation, such as, for example, a silver cation, to the desired metal nanostructure product, such as, for example, a silver nanowire. Such a reduction may be carried out in a reaction mixture that may, for example, comprise one or more polyols, such as, for example, ethylene glycol (EG), propylene glycol (PG), butanediol, glycerol, sugars, carbohydrates, and the like; one or more protecting agents, such as, for example, polyvinylpyrrolidinone (also known as polyvinylpyrrolidone or PVP), other polar polymers or copolymers, surfactants, acids, and the like; and one or more metal ions. These and other components may be used in such reaction mixtures, as is known in the art. The reduction may, for example, be carried out at one or more temperatures from about 90° C. to about 190° C.

### IUPAC Group 15 Metal Ions

Applicant has recognized that IUPAC Group 15 metal ions, such as, for example, bismuth, as Bi³⁺, can be used to prepare silver nanowires, with desirable control of thickness, or length, or both, often with improved control of non-wire contamination. The metal ion catalysts may be provided as metal halides, as metal cations with non-halide anions, or in any other suitable form. These methods are also believed to be applicable to reducible metal cations other than silver cations, including, for example, reducible cations of other IUPAC Group 11 elements, reducible cations of other coinage metals, and the like. The method may also be used to prepare products other than nanowires, such as, for example, nanocubes, nanorods, nanopyramids, nanotubes, and the like. Such products may be incorporated into articles, such as, for example, transparent electrodes, solar cells, light emitting diodes, other electronic devices, medical imaging devices, medical imaging media, and the like.

### EXEMPLARY EMBODIMENTS

U.S. Provisional Application No. 61/488,846, filed May 23, 2011, entitled METAL ION CATALYIS OF METAL ION REDUCTION, METHODS, COMPOSITIONS, AND ARTICLES, which is hereby incorporated by reference in its entirety, disclosed the following 27 non-limiting exemplary embodiments:

A. A method comprising:

providing a composition comprising:
at least one first compound comprising at least one first reducible metal ion;
at least one second compound comprising at least one second metal or metal ion differing in atomic number from said at least one first reducible metal, said at least one second metal or metal ion comprising at least one element from IUPAC Group 15, and
at least one solvent; and

reducing the at least one first reducible metal ion to at least one first metal.

B. The method of embodiment A, wherein the composition further comprises at least one protecting agent.
C. The method of embodiment B, wherein the at least one protecting agent comprises at least one of: one or more surfactants, one or more acids, or one or more polar polymers.
D. The method of embodiment B, wherein the at least one protecting agent comprises polyvinylpyrrolidinone.
E. The method of embodiment B, further comprising inerting the at least one protecting agent.
F. The method of embodiment A, wherein the at least one first reducible metal ion comprises at least one coinage metal ion.
G. The method of embodiment A, wherein the at least one first reducible metal ion comprises at least one ion of an element from IUPAC Group 11.
H. The method of embodiment A, wherein the at least one first reducible metal ion comprises at least one ion of silver.
J. The method of embodiment A, wherein the at least one first compound comprises silver nitrate.
K. The method of embodiment A, wherein the at least one second metal or metal ion comprises bismuth or an ion of bismuth.
L. The method of embodiment A, wherein the at least one second compound comprises at least one salt of said at least one second metal or metal ion.
M. The method of embodiment L, wherein the at least one salt comprises at least one chloride.
N. The method of embodiment A, wherein the at least one solvent comprises at least one polyol.
P. The method of embodiment A, wherein the at least one solvent comprises at least one of: ethylene glycol, propylene glycol, glycerol, one or more sugars, or one or more carbohydrates.
Q. The method of embodiment A, wherein the composition has a ratio of the total moles of the at least one second metal or metal ion to the total moles of the at least one first reducible metal ion from about 0.0001 to about 0.1.
R. The method of embodiment A, wherein the reduction is carried out at one or more temperatures from about 120° C. to about 190° C.
S. The method of embodiment A, further comprising inerting one or more of: the composition, the at least one compound comprising the at least one first reducible metal ion, the at least one second metal or metal ion, or the at least one solvent.
T. The at least one first metal produced according to the method of embodiment A.
U. At least one article comprising the at least one first metal produced according to the method of embodiment A.
V. The at least one article of embodiment U, wherein the at least one first metal comprises one or more nanowires, nanocubes, nanorods, nanopyramids, or nanotubes.
W. The at least one article of embodiment U, wherein the at least one first metal comprises at least one object having an average diameter of between about 10 nm and about 500 nm.
X. The at least one article of embodiment U, wherein the at least one first metal comprises at least one object having an aspect ratio from about 50 to about 10,000.
Y. At least one metal nanowire with an average diameter of between about 10 nm and about 150 nm, and with an aspect ratio from about 50 to about 10,000.
Z. The nanowire of embodiment Y, wherein the at least one metal nanowire comprises at least one coinage metal.
A. The nanowire of embodiment Y, wherein the at least one metal nanowire comprises at least one element of IUPAC Group 11.
B. The nanowire of embodiment Y, wherein the at least one metal nanowire comprises silver.
C. At least one article comprising the at least one metal nanowire of embodiment Y.

### Example

### Example 1

A 500 mL reaction flask containing 280 mL ethylene glycol (EG) was stripped of at least some dissolved gases (hereafter, “degassed”) by bubbling nitrogen into the EG overnight using a glass tube. To this flask was added 0.73 g of a solution of 27 mM BiCl₃ in EG, which had been freshly prepared in a glove bag under N₂. Stock solutions of 0.25 M AgNO₃ in EG and 0.77 M polyvinylpyrrolidinone (PVP) in EG were also degassed overnight by bubbling N₂ into the solutions at room temperature. Two syringes were loaded with 20 mL each of the AgNO₃ and PVP solutions. The reaction mixture was heated to 155° C. under N₂ and then the AgNO₃ and PVP solutions were added at a constant rate over 25 minutes via 12 gauge Teflon syringe needles. The reaction was held at 155° C. for 90 minutes and then allowed to cool to room temperature.

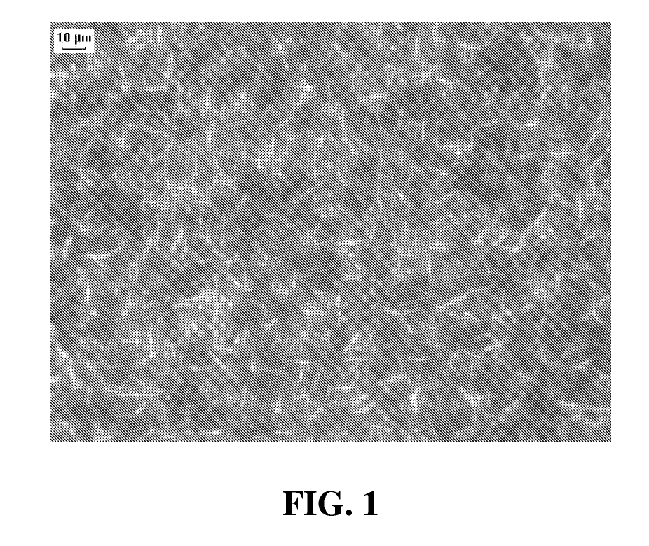

An optical micrograph of the silver nanowire product, with very few nanoparticles, is shown in FIG. 1. The nanowires exhibited an averaged diameter of 49.8±14.3 nm and an average length of 7.5±2.8 μm, based on measurement of at least 100 wires.

### Example 2

### Comparative

To a 500 mL reaction flask was added 280 mL ethylene glycol (EG) and 1.4 g of a freshly prepared 15 mM IrCl₃.3H₂O dispersion in EG. This solution was degassed for 2 hrs by bubbling N₂ into the solution using a glass pipette at room temperature with mechanical stirring while at 100 rpm. Stock solutions of 0.25 M AgNO₃ in EG and 0.84 M polyvinylpyrrolidinone (PVP) in EG were also degassed by bubbling N₂ into the solutions for at least 60 minutes. Two syringes were loaded with 20 mL each of the AgNO₃ and PVP solutions. The reaction mixture was heated to 155° C. under N₂ and the AgNO₃ and PVP solutions were added at a constant rate over 25 minutes via 12 gauge TEFLON® fluoropolymer syringe needles. The reaction was held at 155° C. for 90 minutes then allowed to cool to room temperature.

The reaction product contained nanoparticles and microparticles, with only a few short nanowires.

### Example 3

### Comparative

The procedure of Example 2 was repeated, using 2.9 g of a freshly prepared 7.0 mM dispersion of K₂IrCl₄ in EG, instead of the IrCl₃.3H₂O dispersion. The reaction was carried out at 145° C., instead of 155° C.

The reaction product contained only a few fine nanowires.

### Example 4

### Comparative

The procedure of Example 2 was repeated, using 2.3 g of a freshly prepared 7.0 mM dispersion of InCl₃.4H₂O in EG, instead of the IrCl₃.3H₂O dispersion.

The reaction product contained no nanowires.

### Example 5

### Comparative

To a 100 mL reaction flask was added 50 mL ethylene glycol (EG) and 0.29 g of 7.0 mM AuCl₃ in EG. This solution was degassed for 2 hrs by bubbling N₂ into the solution using a glass pipette at room temperature with mechanical stirring while at 100 rpm. Stock solutions of 0.25 M AgNO₃ in EG and 0.84 M polyvinylpyrrolidinone (PVP) in EG were also degassed by bubbling N₂ into the solutions for at least 60 minutes. Two syringes were loaded with 3 mL each of the AgNO₃ and PVP solutions. The reaction mixture was heated to 145° C. under N₂ and the AgNO₃ and PVP solutions were added at a constant rate over 25 minutes via 20 gauge TEFLON® fluoropolymer syringe needles. The reaction was held at 145° C. for 150 minutes then allowed to cool to room temperature.

Samples taken after 15, 30, 60, 90, 120, and 150 min of reaction appeared to have only nanoparticles, but no nanowires.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A method comprising:
providing a composition comprising:
at least one first compound comprising at least one first reducible metal ion;
at least one second compound comprising at least one second metal or metal ion differing in atomic number from said at least one first reducible metal, said at least one second metal or metal ion comprising at least one element from IUPAC Group 15, and
at least one solvent; and
reducing the at least one first reducible metal ion to at least one first metal nanowire.

2. The method of claim 1, wherein the at least one first reducible metal ion comprises at least one coinage metal ion.

3. The method of claim 1, wherein the at least one first reducible metal ion comprises at least one ion of an element from IUPAC Group 11.

4. The method of claim 1, wherein the at least one first reducible metal ion comprises at least one ion of silver.

5. The method of claim 1, wherein the at least one second metal or metal ion comprises bismuth or an ion of bismuth.

6. The method of claim 1, wherein the at least one second metal or metal ion is in its +3 oxidation state.

7. The method of claim 1, wherein the at least one second compound comprises at least one salt of said at least one second metal or metal ion.

8. The method of claim 7, wherein the at least one salt comprises at least one chloride.

9. The method of claim 1, wherein the at least one solvent comprises at least one polyol.

10. The at least one first metal nanowire produced according to the method of claim 1.
